(19) United States
(12) Patent Application Publication
(10) Pub. No.: US 2011/0039544 A1
(43) Pub. Date: Feb. 17, 2011

(54) METHOD AND APPARATUS FOR INDICATING ANTICIPATED AVAILABLE DATA RATES IN A WIRELESS COMMUNICATION NETWORK

(76) Inventor: Tracy Fulghum, Durham, NC (US)

Correspondence Address: ERICSSON INC., 6300 LEGACY DRIVE, M/S EVR 1-C-11, PLANO, TX, 75024, US

(21) Appl. No.: 12/540,670

(22) Filed: Aug. 13, 2009

(51) Int. Cl. H04W 24/00

(52) U.S. Cl. 455/423

(57) ABSTRACT

Contemporary wireless communication devices provide high data rate services, but the actual data rate achievable by a given device at a given time may be substantially less than a relevant maximum data rate that is theoretically achievable. Accordingly, among its several advantages, the present invention manages users' expectations for data service performance by providing them with an indication of the available data rate anticipated for data services, in relation to a maximum data rate. In one embodiment, a user's wireless communication device displays a data rate gauge that indicates the anticipated available rate in relation to the maximum rate. Doing so sets the user's expectations for data service performance in advance of engaging in the data service.

### FIELD OF THE INVENTION

The present invention generally relates to wireless communications, and particularly relates to providing users of data services with an indication of anticipated available data rates.

### BACKGROUND

Many wireless communication devices provide a received signal strength indication (RSSI). RSSI provides a reasonably good indication of performance for voice and other low-rate services. However, in the growing data-centric wireless environment of high-rate data services, such as Long term Evolution (LTE) and Wideband CDMA (W-CDMA), performance depends increasingly on factors other than RSSI. For example, received signal strength may be high, but the data services environment nonetheless may be degraded by interfering signals from other cells, time dispersion of the channel, or other channel conditions that are not indicated by RSSI.

By displaying a high RSSI value onscreen, the wireless communication device may lead its user to an incorrect assumption about the data services performance that is currently available. This incorrect expectation may lead to user frustration and dissatisfaction with the device, and with the service provider.

### SUMMARY

Contemporary wireless communication devices provide high data rate services, but the actual data rate achievable by a given device at a given time may be substantially less than a relevant maximum data rate that is theoretically achievable. Accordingly, among its several advantages, the present invention manages users' expectations for data service performance by providing them with an indication of the available data rate anticipated for data services, in relation to a maximum data rate. In one embodiment, a user's wireless communication device displays a data rate gauge indicating the anticipated available data rate relative to the maximum data rate. In this manner, the user's expectations for data service performance are set in advance of engaging in a data service, based on predicting the achievable data rate.

In another embodiment, a method of indicating anticipated available data rate via a user interface on a wireless communication device comprises computing an anticipated available data rate as a function of current data service conditions, and displaying a representation of the anticipated available data rate in relation to a maximum data rate, via the user interface. Further, in at least one embodiment, the method includes representing the current data service conditions with two or more data rate factors, including a channel factor representing current channel conditions and a congestion factor representing current network congestion conditions. Computing the anticipated available data rate comprises determining the anticipated available data rate as a function of the two or more data rate factors.

In another embodiment, a wireless communication device comprises a radio transceiver and a processor operatively associated with it. The radio transceiver is configured to communicate with a supporting wireless communication network, including data service communications. The processor is configured to compute an anticipated available data rate for data service communications as a function of current data service conditions, and display a representation of the anticipated available data rate in relation to a maximum data rate, via a user interface of the wireless communication device. In the same or other embodiments, the processor is configured to represent the current data service conditions using two or more data rate factors, such as a channel factor representing current channel conditions and a congestion factor representing current network congestion conditions.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a wireless communication device, shown in context with a supporting wireless communication network.

FIG. 2 is a logic flow diagram of one embodiment of a method of a wireless communication device determining and displaying a representation of anticipated available data rate relative to a maximum data rate.

FIGS. 3 is a block diagram of one embodiment of a processor, for use in a wireless communication device, in determining an anticipated available data rate as a function of two or more data rate factors.

FIGS. 4-7 are diagrams of different embodiments of a representation of the anticipated available data rate, as may be depicted on a user interface display of a wireless communication device.

FIG. 8 is a diagram of one embodiment of a memory and associated data items, such as may be used by a wireless communication device for determining an anticipated available data rate.

FIG. 9 is a diagram of a look-up table data structure, such as may be maintained in a memory of a wireless communication device, for use in determining an anticipated available data rate.

### DETAILED DESCRIPTION

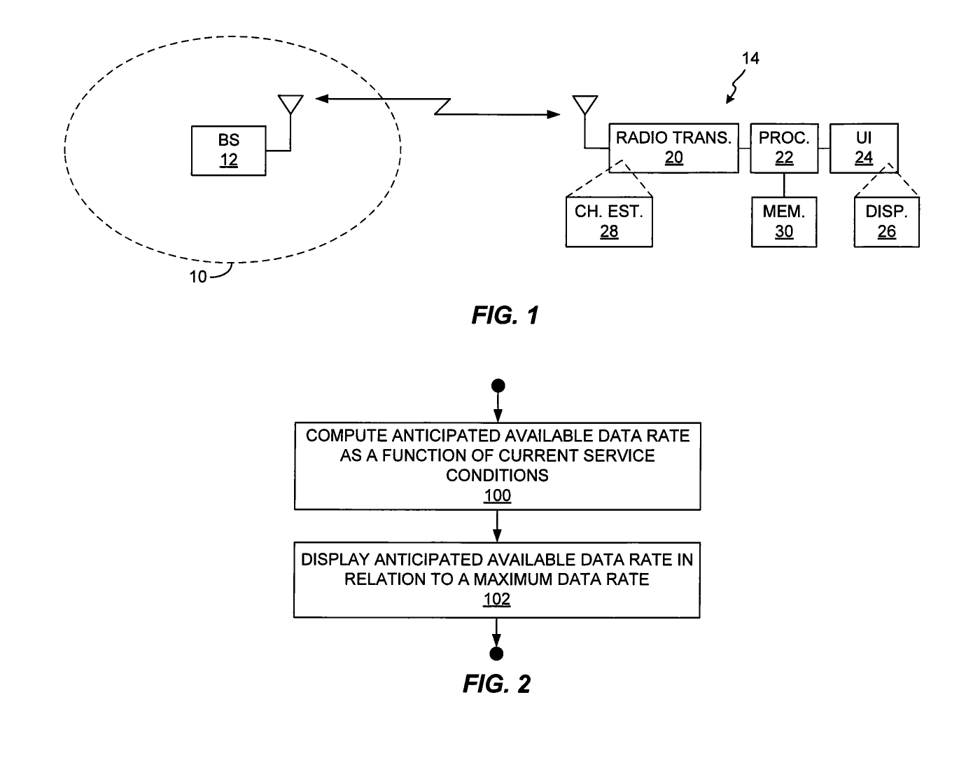

FIG. 1 illustrates a wireless communication network 10 that provides data services to wireless communication devices 14. The diagram simplifies its presentation of the network 10 by depicting only one base station 12 serving only one device 14. Those skilled in the art will appreciate that many devices 14 can be served by the network 10, and that the network 10 may include multiple base stations 12, and numerous other entities, and may be divided into Radio Access Network (RAN) and a Core Network (CN). As such details are not germane to understanding the present invention, they are omitted.

What is germane is that the network 10 provides communication services, including data services to the device 14. As non-limiting examples, the network 10 comprises a Wideband CDMA or Long Term Evolution (LTE) network, and the device 14 correspondingly comprises a compatible mobile terminal. Supporting these communications, the device 14 includes a radio transceiver 20, a processor 22, and a user interface 24, including a display 26 and/or other visual indicators.

The radio transceiver 20 is configured to communicate with a supporting wireless communication network—e.g., the network 10—and it supports data service communications with the network 10. The processor 22 is operatively associated with the radio transceiver 20. As illustrated in the method of FIG. 2, it is configured to compute an anticipated available data rate for data service communications as a function of current data service conditions (Block 100), and display a representation of the anticipated available data rate in relation to a maximum data rate, via the user interface 26 of the device 14 (Block 102).

In one or more embodiments, the processor 22 is configured to represent the current data service conditions with two or more data rate factors, including a channel factor representing current channel conditions and a congestion factor representing current network congestion conditions. In at least one such embodiment, the radio transceiver 20 includes a channel estimation circuit 28 that tracks current channel conditions and provides, for example, a dynamically updated Channel Quality Indicator (CQI), signal-to-noise-plus-interference ratio (SINR) value, or other channel quality metric that serves as the channel factor, or which provides for derivation of the channel factor. The channel factor thus can be understood as a dynamically updated value that varies in relation to changing channel conditions, such as changing channel quality, changing fading type/rate, changing time dispersiveness, etc.

Those skilled in the art will also appreciate that the channel estimation circuit 28 could be implemented in whole or in part within the processor 22, depending upon the level of integration between the processor 22 and the radio transceiver 20. In at least one embodiment, the processor 22 provides for overall device control and housekeeping as regards the device 14. It also may interface with a DSP or other digital processor that is included in the radio transceiver 20 for baseband signal processing and radio transceiver control. Those skilled in the art will also appreciate that the radio transceiver 20 may include analog front-end filter and amplifier circuits, down-conversion and analog-to-digital conversion circuits, and baseband digital signal processing (DSP) circuits, for received and transmitted signal processing.

Still further, those skilled in the art will appreciate that in one or more embodiments, the processor 22 comprises a type of digital processor, such as a microprocessor or DSP based circuit. As such, the configuration of the processor 22, as regards some or all of the anticipated available data rate processing, may be based in whole or in part on computer program instructions stored in a computer-readable medium. Those instructions may comprise one or more computer programs, the execution of which configures the processor 22 in accordance with the teachings presented herein. For example, the processor 22 includes or is associated with memory 30 (shown in FIG. 1). The memory 30 includes, for example, EEPROM, FLASH, or other non-volatile storage, for maintaining the computer program instructions, possibly along with various configuration data, default information, etc.

However, whether the processor 22 is configured via hardware, software, or a mix of both, it computes anticipated available data rates as a function of current data service conditions. Such conditions can be broadly understood as one or more conditions bearing on the expected data rate performance of the device 14, or the expected data rate performance of the cooperative combination of the device 14 and the network 10. Thus, the “anticipated available data rate” differs significantly from a simple tracked average of past throughput, and it differs significantly from the maximum data rate, which may be a known theoretical data rate corresponding to ideal conditions, for example, or which may be an otherwise set or defined maximum, such as an upper limit imposed by a subscriber agreement.

Further, it should be understood that the anticipated available data rate represents a predicted rate, not the rate that is or will be achieved on the commencement of data services. In that regard, it represents an intelligent estimate by the device 14 as to what data rate will be realized upon commencement (or resumption) of active data service, in relation to the relevant maximum data rate. Because it is computed in relation to the relevant maximum data rate—which could be different for different service types, different subscription agreements, different network types, etc.—the anticipated available data rate provides the device user with a meaningful indication of the data rate performance that he or she can expect.

That understanding may cause the user to defer data intensive communications until a better anticipated rate is indicated, or at least may cause the user to temper his or her expectations for how quickly such communications will occur. In either instance, there is a distinct tendency to moderate or eliminate user disappointment, and thereby enhance user satisfaction. Moreover, these results are achieved even if the user is unaware of what the maximum data rate is; rather it is enough for the user to know that the anticipated available data rate is one-quarter, or one-half, etc., of the maximum rate.

Of course, it is necessary that the anticipated available data rate predications made by the processor 22 are accurate enough to be useful in guiding the user's expectations. To that end, one or more embodiments of the processor 22 represent the current data service conditions using two or more data rate factors that bear on expected data rate performance. Preferably, the processor 22 uses at least those factors bearing most directly on the expected data rate performance. In at least one embodiment, the processor 22 represents the current data service conditions using a channel factor that is determined in dynamic fashion by the processor 22, in accordance with changing channel conditions (e.g., changing channel quality), and a congestion factor, which reflects the current (or last reported) level of network congestion. In this regard, “congestion” should be understood as the level of loading or overall network activity, at least as relates to the network's ability to deliver data traffic or otherwise service data connections.

As such, the congestion factor may also be regarded as a “loading” or “traffic level” factor that provides some indication of whether or to what extent high data rate traffic can be exchanged between the network 10 and the device 14. For example, the base station 12 generally would not be expected to be capable of providing maximum rate traffic to a large number of devices 14, but rather likely would have to throttle back some or all of those high-rate data connections.

Such congestion levels can be signaled by the network 10, and, in one or more embodiments contemplated herein, the device 14 receives signaling from the network that indicates current network congestion conditions, or provides a value from which the device 14 can derive current network congestion conditions. As a non-limiting example, the network 10 may signal a multi-bit value on a control or overhead channel that indicates network congestion as none, low, medium, or high. Thus, in one or more embodiments, the processor 22 is configured to receive signaling from the network 10, via the radio transceiver 20, that provides an indication or measure of network congestion, for use as said congestion factor, or for use in computing said congestion factor.

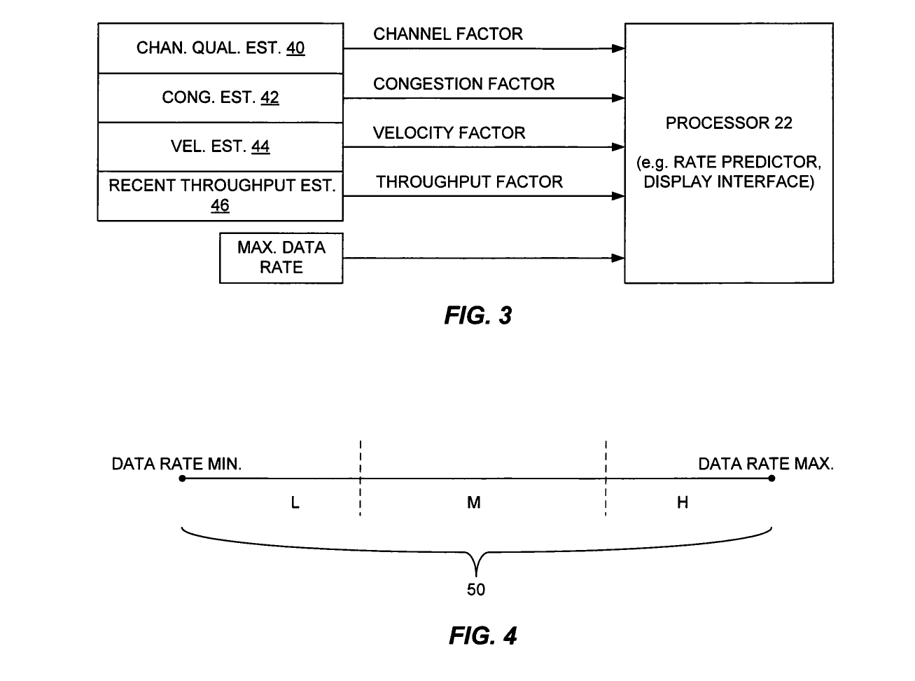

More broadly, the processor 22 is configured to determine the anticipated available data rate as a function of the two or more data rate factors (bearing on data rate performance). For example, FIG. 3 provides a non-limiting example of data rate factors that can be considered. Of course, not all embodiments consider all of the illustrated factors.

With that understanding, FIG. 3 illustrates that the processor 22 may consider any two or more of: a channel factor from a channel quality estimator 40, which may be part of the channel estimation circuit 28; a congestion factor from a congestion estimator 42, which may be driven by network-signaled congestion information; a velocity factor from a velocity estimator 44, which may use Doppler-based or other velocity/speed measurement techniques to determine the device's relative rate of travel; and a throughput factor from a recent throughput estimator 46, which may track past data rates, as actually achieved. In particular, the throughput estimator 46 may average data rates achieved for the most recent transmissions, and may use exponential forgetting, etc., to emphasize more recently achieved throughputs. FIG. 3 also illustrates that the maximum data rate may be provided to the processor 22, from memory as a dynamically updated or static value.

Having access to maximum data rate information allows the processor 22 to determine or otherwise display an indication of the anticipated available data rate in relation to the maximum. FIG. 4 shows one example, where displaying a representation 50 of the anticipated available data rate comprises displaying an alphanumeric character from a defined set of alphanumeric characters that map to different data rate ranges, as bounded by the maximum data rate. In the illustration, the representation 50 comprises a selected one of the characters “L,” “M,” or “H,” which respectively map to low, medium, and high ranges of anticipated available data rates relative to the maximum data rate. Of course, the representation 50 could comprise all three characters superimposed on a line of increasing data rates, where the anticipated range is indicated by highlighting the corresponding character.

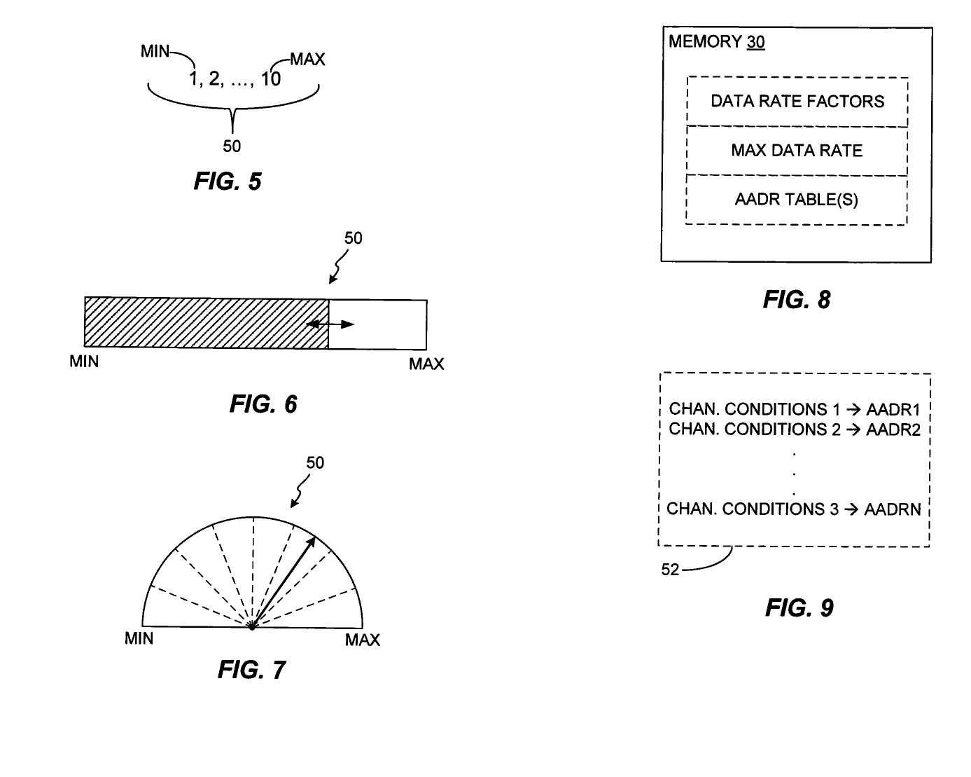

FIG. 5 illustrates a similar representation 50, but where the number of characters or symbols used is greater, providing greater resolution for indicating the anticipated available data rate. In particular, FIG. 5 depicts using the set of numbers from 1 to 10, wherein 1 represents the lowest value for the anticipated available data rate, and 10 represents the highest value, i.e., the defined maximum data rate. Again, the device 14 may simply display whichever number is appropriate for the determined value of the anticipated available data rate, or it may display all ten numbers and highlight the appropriate one.

FIGS. 6 and 7 show still other variations. In FIG. 6, the representation 50 comprises a type of data rate gauge in the form of a bar graph depiction, where the filled/non-filled portions of the bar indicate the anticipated available data rate in relation to the maximum data rate. In another embodiment, FIG. 7 depicts the representation 50 as another type of data rate gauge that is reminiscent of a speedometer, wherein a dial pointer indicates the anticipated available data rate in relation to the maximum data rate, which corresponds to the maximum dial position.

Broadly, then, in one or more embodiments, displaying the representation 50 of the anticipated available data rate comprises displaying a data rate gauge indicating the anticipated available data rate relative to the maximum data rate. More broadly, in one or more embodiments, displaying the representation 50 of the anticipated available data rate comprises displaying characters or graphics that indicate the anticipated available data rate on a scale defined by the maximum data rate.

Regardless of how the representation 50 is rendered, FIG. 8 illustrates the memory 30 of the device 14 storing (dynamically or statically) the data rate factors, the maximum data rate, and, in at least one embodiment, one or more anticipated available data rate (AADR) tables. For example, in one embodiment the processor 22 implements a method whereby determining the anticipated available data rate comprises retrieving the anticipated available data rate as a pre-computed anticipated available data rate value from a look-up table comprising pre-computed anticipated available data rate values. Further, in at least one such embodiment, retrieving the anticipated available data rate value from the look-up table comprises using one or more of the two or more data rate factors to index into one or more look-up tables, each comprising pre-computed anticipated available data rate values corresponding to different values or ranges of the one or more data rate factors.

FIG. 9 illustrates an example look-up table 52, which comprises pairings of channel conditions and corresponding anticipated available data rate values; e.g., CHAN. CONDITIONS 1 map to MDR 1, CHAN. CONDITIONS 2 map to MDR 2, and so on. With this arrangement, the current value of the channel factor is used to index into the table 52, to select the corresponding MDR value. Further, there may be different versions of the table 52, corresponding to any one or more of different levels of network congestion, different velocities, etc., such that one or more other data rate factors can be used to pick which table version to use.

Alternatively, there may simply be one table, indexed by one data rate factor, but where the processor further modifies (e.g., fractionally reduces) the anticipated available data rate value retrieved from that table, in accordance with one or more additional data rate factors. As another alternative, the device 14 may use fuzzy logic to determine the anticipated available data rate. For example, the universe of possible data rates, ranging from zero or some default minimum up to the relevant maximum data rate may be divided into a number of overlapping sub-ranges, serving as fuzzy sets. One or more of the data rate factors can then be used to map into that domain, or they can be used to define one or more additional domains subdivided into fuzzy sets, for a compound fuzzy mapping.

Still further, the mapping of data rate factors into anticipated available data rates may be based on neural network mapping. Thus, in one or more embodiments, the processor 22 includes a neural processor that learns the data-factor-to-anticipated-available-rate mappings, for various factors or combinations of factors. Alternatively, such learning may be done beforehand, based on simulations or empirical processing, and the results programmed into the processor 22, such that it simply determines values for the data rate factors in use, and maps them according to the programmed criteria.

In any case, there may be one or more data rate factors that have a dominant influence on data rates, and they may be considered primarily or exclusively by the processor 22. In at least one embodiment, the processor 22 represents the current data service conditions at least with a channel factor representing current channel conditions and a congestion factor representing current network congestion conditions. Here, computing the anticipated available data rate comprises determining the anticipated available data rate as a function of the channel and congestion factors.

As noted, the device 14 may receive signaling from the network 10 that provides an indication or measure of network congestion, for use as said congestion factor, or for use in computing said congestion factor. Further, additional factors may include a mobility factor representing a velocity or speed estimate for the device 14, and a throughput factor representing recent data throughput of the device 14.

Regardless of the particular factors used, or the particular mix of factors, computing the anticipated available data rate as a function of the current data service conditions comprises computing the anticipated available data rate as a function of two or more data rate factors representing the current data service conditions. In one embodiment, computing the anticipated available data rate as a function of the current data service conditions comprises determining what fraction of the maximum data rate is expected to be achievable, in view of the current data service conditions. For example, the factors may operate as fractional scaling factors applied to the maximum data rate, or may otherwise be used to compute a “discount” or other offset or back-off from the maximum data rate.

The maximum data rate itself is a known or calculable value, be it static or dynamic. For example, the device 14 may store a predefined value for the maximum data rate in a memory of the wireless communication device. Further, it may determine the maximum data rate based on one or more of: a service level agreement governing operation of the wireless communication device, data rate limitations of a wireless communication network supporting the wireless communication device, and data rate limitations of the wireless communication device.

Still further, it should be understood that the device 14 may store different maximum data rates, corresponding to different network and/or device capabilities or modes, different types of networks, different types of data services, etc. The device 14 may therefore use and/or store a look-up table of maximum data rates, and/or maximum data rate information can be signaled to the device 14 by the network 10.

As a general proposition, the maximum data rate used at any given time by the device 14 can be understood as the best or maximum data rate that is allowed or can be theoretically achieved for a given type of data service, and given network and device capabilities. In that manner, the anticipated available data rate gives the user an accurate sense of how much or what fraction of that maximum data rate is expected to be available at any given time.

Those skilled in the art will further appreciate that the present invention is not limited by the foregoing description or the accompanying drawings. Indeed, the present invention is limited only by the following appended claims and their legal equivalents.

What is claimed is:

1. A method of indicating anticipated available data rate via a user interface on a wireless communication device, the method comprising:
computing an anticipated available data rate as a function of current data service conditions; and
displaying a representation of the anticipated available data rate in relation to a maximum data rate, via the user interface.

2. The method of claim 1, further comprising representing the current data service conditions with two or more data rate factors, including a channel factor representing current channel conditions and a congestion factor representing current network congestion conditions, and wherein computing the anticipated available data rate comprises determining the anticipated available data rate as a function of the two or more data rate factors.

3. The method of claim 2, wherein the two or more data rate factors further include at least one of the following factors: a mobility factor representing a velocity or speed estimate for the wireless communication device, and a throughput factor representing recent data throughput of the wireless communication device.

4. The method of claim 2, further comprising receiving signaling from the wireless communication network that provides an indication or measure of network congestion, for use as said congestion factor, or for use in computing said congestion factor.

5. The method of claim 2, wherein determining the anticipated available data rate comprises retrieving the anticipated available data rate as a pre-computed anticipated available data rate value from a look-up table comprising pre-computed anticipated available data rate values.

6. The method of claim 5, wherein retrieving the anticipated available data rate value from the look-up table comprises using one or more of the two or more data rate factors to index into one or more look-up tables, each comprising pre-computed anticipated available data rate values corresponding to different values or ranges of the one or more data rate factors.

7. The method of claim 1, wherein computing the anticipated available data rate as a function of the current data service conditions comprises computing the anticipated available data rate as a function of two or more data rate factors representing the current data service conditions.

8. The method of claim 1, wherein computing the anticipated available data rate as a function of the current data service conditions comprises determining what fraction of the maximum data rate is expected to be achievable, in view of the current data service conditions.

9. The method of claim 1, wherein displaying the representation of the anticipated available data rate comprises displaying an alphanumeric character from a defined set of alphanumeric characters that map to different data rate ranges, as bounded by the maximum data rate.

10. The method of claim 1, wherein displaying the representation of the anticipated available data rate comprises displaying a data rate gauge indicating the anticipated available data rate relative to the maximum data rate.

11. The method of claim 1, wherein displaying the representation of the anticipated available data rate comprises displaying a gauge or other graphical icon that indicates the anticipated available data rate on a scale defined by the maximum data rate.

12. The method of claim 1, further comprising storing a predefined value for the maximum data rate in a memory of the wireless communication device.

13. The method of claim 1, further comprising determining the maximum data rate based on one or more of: a service level agreement governing operation of the wireless communication device, data rate limitations of a wireless communication network supporting the wireless communication device, and data rate limitations of the wireless communication device.

14. A wireless communication device comprising:
a radio transceiver configured to communicate with a supporting wireless communication network, including data service communications; and
a processor operatively associated with the radio transceiver and configured to:
compute an anticipated available data rate for data service communications as a function of current data service conditions; and
display a representation of the anticipated available data rate in relation to a maximum data rate, via a user interface of the wireless communication device.

15. The wireless communication device of claim 14, wherein the processor is configured to represent the current data service conditions with two or more data rate factors, including a channel factor representing current channel conditions and a congestion factor representing current network congestion conditions, and wherein the processor is configured to determine the anticipated available data rate as a function of the two or more data rate factors.

16. The wireless communication device of claim 15, wherein the processor is configured to receive signaling from the wireless communication network, via the radio transceiver, that provides an indication or measure of network congestion, for use as said congestion factor, or for use in computing said congestion factor.

17. The wireless communication device of claim 15, wherein the processor is configured to determine the anticipated available data rate by retrieving the anticipated available data rate as a pre-computed anticipated available data rate value from a look-up table stored in memory, and wherein the look-up table comprises pre-computed anticipated available data rate values.

18. The wireless communication device of claim 17, wherein the processor is configured to retrieve the anticipated available data rate by using one or more of the two or more data rate factors to index into one or more look-up tables, each comprising pre-computed anticipated available data rate values corresponding to different values or ranges of values of the one or more data rate factors.

19. The wireless communication device of claim 14, wherein the processor is configured to compute the anticipated available data rate by determining what fraction of the maximum data rate is expected to be achievable, in view of the current data service conditions.

20. The wireless communication device of claim 14, wherein the processor is configured to display the representation of the anticipated available data rate by displaying, via the user interface, an alphanumeric character from a defined set of alphanumeric characters that map to different data rate ranges, as bounded by the maximum data rate.

21. The wireless communication device of claim 14, wherein the processor is configured to display the representation of the anticipated available data rate by displaying, via the user interface, a gauge or other graphical icon that indicates the anticipated available data rate on a scale defined by the maximum data rate.
